(19) United States
(12) Patent Application Publication
(10) Pub. No.: US 2018/0308139 A1
(43) Pub. Date: Oct. 25, 2018

(54) Systems And Methods For Auction Customer Engagement Platform

(71) Applicant: Websoft Limited, Tauranga (NZ)

(72) Inventors: Brendan Roderick Howell, Tauranga (NZ); Peter John Howell, Tauranga (NZ)

(21) Appl. No.: 15/769,662

(22) PCT Filed: Oct. 20, 2016
(86) PCT No.: PCT/NZ2016/050172

§ 371 Date: Apr. 19, 2018

(30) Foreign Application Priority Data
Oct. 20, 2015 (NZ) 713482

(51) Int. Cl. G06Q 30/06

(52) U.S. Cl. CPC G06Q 30/0611; H04L 67/12; G06Q 30/0641

(57) ABSTRACT

The invention relates to a system for operating a reverse auction for a number of users. The system has a server with a clock, reverse auction data including a start time and a subscriber list, the server in communication with a plurality of user devices of a plurality of users via a data communication network. The server is configured to transmit the auction data to one or more users in the subscriber list, receive data from a user in the subscriber list indicative of the user viewing the auction, create an active user list as a subset of the subscriber list based on data received from each member indicative of the user viewing the reverse auction, synchronise each user device in the active user list with the clock, receive data from a user in the active users list indicative of participating in the reverse auction, create a participant users list as a subset the active users list and receive bid data and clock data from a user device in the participant users list. The bid data includes detection of movement from one location of an interface of a user device corresponding to a button to a second location of the interface of the user device corresponding to a target. A winning user is determined by the clock data representing a bid made in the least amount of time since a start of the reverse auction.

### FIELD OF THE INVENTION

The invention relates to providing consumer engagement with brands retail outlets using electronic devices.

### BACKGROUND TO THE INVENTION

Unless otherwise indicated herein, the materials described in this section are not prior art to the claims in this application and are not admitted to be prior art by inclusion in this section.

Online retailing is affecting the revenue of physical retail outlets due to a reduction of the numbers of consumers who may physically visit a store. Some retailers are motivated to have consumers visit their store as they are able to use in store marketing techniques to sell products which are often more effective at engaging consumers than online marketing techniques. There is a desire to motivate those consumers to visit a physical retail location where they may prefer to shop online.

It is an object of the present invention to go at least some way toward improving upon the state of the prior art or which at least provides the public with a useful choice. Other objects of the invention may become apparent from the following description which is given by way of example only.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY OF THE INVENTION

Accordingly, in one broad aspect, the invention consists in a method of conducting a reverse auction for an audience of subscriber users, the subscriber users each having a user device adapted for communication with and control by a remote auction server adapted to host the reverse auction, the method comprising: storing, on the server, a list of subscriber users; storing, on the server, reverse auction data comprising: an item subject to the reverse auction, an initial cost of the item subject to the reverse auction, a time when the reverse auction is due to commence; generating, on the server, a clock signal adapted to provide a time synchronisation signal; determining one or more live users from the list of subscriber users, creating a live user list of determined live users, then controlling the user device of each user on the live user list to display the reverse auction data; synchronising the user device of each live user with the server clock; commencing the reverse auction at the time the reverse auction is due to commence; detecting a user from the live user list has selected a first location on an interface of their user device corresponding to a button graphic, storing a list of participant users on the server as a subset of the live users, then notifying each participant user that they are eligible to participate in the reverse auction; controlling the user device of each live user to display a countdown time on the interface of each user device, synchronised with the server clock and associated with a time remaining in the reverse auction process; controlling the user device of each live user to display the cost of the item on the interface of each user device and decreasing the cost of the item based on the countdown time; controlling the user device of each live user to display a target graphic on the interface of each user device of at least each participant user and shown at a second location of the interface; detecting a dragging motion from the first location of the interface of a user device of a participant user to a second location; and determining the dragging motion has reached the second location, determining the clock time the dragging motion reached the second location then, ending the reverse auction.

In some embodiments, determining a winning user from the list of participant users by determining the user who reached the second location first according to the first user to reach the second location according to the highest clock time, and notifying the winning user they have won the reverse auction.

In some embodiments, notifying the winning user comprises notifying the winning user of the cost of the item at the time the reverse auction was stopped according to the clock.

In some embodiments, notifying the winning user further comprises displaying unique media content to the winning user.

In some embodiments, wherein each participant user is determined after each user has selected the first location of the interface for at least a predetermined selection time has elapsed.

In some embodiments, the predetermined selection time is about three seconds.

In some embodiments, the method further comprises detecting deselection of the first location by a participant user, once the reverse auction has commenced and before the reverse auction has ended, then removing that participant user from the participant user list.

In some embodiments, the method further comprises displaying graphics indicative of a swipe direction to users eligible to participate in the reverse auction.

In some embodiments, the graphics indicative of a swipe direction are indicative of a swipe path from the button graphic to the target graphic.

In some embodiments, the method further comprises displaying a countdown media graphic when the first countdown timer is less than a predetermined time threshold.

In some embodiments, the predetermined time threshold is five seconds.

In some embodiments, the method further comprises displaying a countdown time to the time the reverse auction is due to start.

In some embodiments, the cost of the item subject to the reverse auction decreases from the initial cost to zero during the duration of the second countdown time.

In some embodiments, the method further comprises displaying advertising media on each user device before the reverse auction commences.

In some embodiments, the method further comprises notifying each participant user of secondary prize information when the reverse auction has ended.

In some embodiments, the secondary prize information is one or more vouchers or coupons.

In some embodiments, the method further comprises determining the length of time each participant user has selected the first location for then determining the value of the vouchers is based on that length of time.

In some embodiments, the item subject to reverse auction is provided by one or more supporting businesses.

In some embodiments, the method further comprises displaying advertising media to the users on the subscriber list before the reverse auction commences.

In some embodiments, ending the reverse auction comprises displaying advertising media to users on the participant list.

In another broad aspect the invention consists in a non-transitory computer-readable medium product, the non-transitory computer-readable medium containing instructions thereon that, when executed by at least one processor, perform a method, the method comprising: causing a reverse auction for an audience of subscriber users, the subscriber users each having a user device adapted for communication with and control by a remote auction server adapted to host the reverse auction; the method further comprising: storing, on the server, a list of subscriber users; storing, on the server, reverse auction data comprising: an item subject to the reverse auction, an initial cost of the item subject to the reverse auction, a time when the reverse auction is due to commence; generating, on the server, a clock signal adapted to provide a time synchronisation signal; determining one or more live users from the list of subscriber users, creating a live user list of determined live users, then controlling the user device of each user on the live user list to display the reverse auction data; synchronising the user device of each live user with the server clock; commencing the reverse auction at the time the reverse auction is due to commence; detecting a user from the live user list has selected a first location on an interface of their user device corresponding to a button graphic, storing a list of participant users on the server as a subset of the live users, then notifying each participant user that they are eligible to participate in the reverse auction; controlling the user device of each live user to display a countdown time on the interface of each user device, synchronised with the server clock and associated with a time remaining in the reverse auction process; controlling the user device of each live user to display the cost of the item on the interface of each user device and decreasing the cost of the item based on the countdown time; controlling the user device of each live user to display a target graphic on the interface of each user device of at least each participant user and shown at a second location of the interface; detecting a dragging motion from the first location of the interface of a user device of a participant user to a second location; and determining the dragging motion has reached the second location, determining the clock time the dragging motion reached the second location then, ending the reverse auction.

In another broad aspect the invention consists in a system for a reverse auction, comprising: an auction server comprising: a database configured to store a list of subscriber users; a clock; a data communication network in communication with the information server; a plurality of user devices, each user device having a communication module configured to communicate with the auction server via the data communication network; wherein each user device has, a memory configured to store an application program and an interface configured to facilitate display and operation of the application program by the processor, wherein the application program includes instructions to: receive, from the server, reverse auction data comprising: an item subject to the reverse auction, an initial cost of the item subject to the reverse auction, a time when the reverse auction is due to commence; receive, from the server, a clock signal adapted to provide a time synchronisation between the user device and the server; display the reverse auction data on the interface of the user device; commence the reverse auction at the time the reverse auction is due to commence; display a button graphic at a first location on the interface; send data to the server indicative of the user selecting the button graphic; receive notification the user is eligible to participate in the reverse auction; control the user device of each live user to display a countdown time on the interface the user device, synchronised with the server clock and associated with a time remaining in the reverse auction process; control the user device of each live user to display the cost of the item on the interface of each user device and decreasing the cost of the item based on the countdown time; control the user device of each live user to display a target graphic on the interface of each user device of at least each participant user and shown at a second location of the interface; detect a dragging motion from the first location of the interface of a user device of a participant user to a second location; and determine the dragging motion has reached the second location, determining the clock time the dragging motion reached the second location then, display graphics indicative of the reverse auction ending.

In another broad aspect the invention consists in a system comprising a server having clock, reverse auction data including a start time and a subscriber list, the server in communication with a plurality of user devices of a plurality of users via a data communication network, the server configured to: transmit the auction data to one or more users in the subscriber list; receive data from a user in the subscriber list indicative of the user viewing the auction; create an active user list as a subset of the subscriber list based on data received from each member indicative of the user viewing the reverse auction; synchronise each user device in the active user list with the clock; receive data from a user in the active users list indicative of participating in the reverse auction; create a participant users list as a subset the active users list; receive bid data and clock data from a user device in the participant users list; wherein the bid data comprises detection of movement from one location of an interface of a user device corresponding to a button to a second location of the interface of the user device corresponding to a target; and wherein a winning user is determined by the clock data representing a bid made in the least amount of time since a start of the reverse auction.

In another broad aspect the invention consists in a system comprising a population of user electronic devices and a remote controller in communication with the user devices via a data communication network, the controller operable to cause a display of a user electronic device of a reverse auction to: present reverse auction details comprising an indication of the time remaining in the reverse auction and an indication of the current price of the auction; present an operator on the display of each user electronic device moveable from first position on the display to a second position on the display by a user of the user device; wherein arrival of the operator at the second position on a user electronic device causes that device to send bid data to the remote controller to effect a bid to occur on the reverse auction.

In some embodiments, the remote controller is further operable to provide time synchronisation data to each user device in the population of user electronic devices, and the bid data further comprises time stamp data derived from the time synchronisation data.

In another broad aspect the invention consists in a graphical user interface for a display of a user electronic device, the user comprising a user contained on a subscriber database having connection via a network to the user electronic device, the interface comprising: an indication of auction details comprising an indication of the time remaining for the auction and an indication of the current price of the auction, a first graphical object selectable to enable bidding, wherein, when selected, the first graphical object is replaced by a second graphical object and data comprising user identification information is sent to a remote server configured to generate a participant database, the second graphical object selectable to enable bidding on the auction.

In another broad aspect the invention consists in a system for controlling an online sale, comprising: a programmable control device in communication with a plurality of electronic devices contained in a database of user electronic devices via a network, wherein each of the plurality of electronic devices is configured to receive and display auction data, the auction data comprising at least an item-for-sale and an auction start time, wherein the plurality of electronic devices are configured, or configurable, to provide a graphical user interface comprising: an indication of auction details comprising an indication of the time remaining for the auction and an indication of the current price of the auction, a first graphical object selectable to enable bidding, wherein, when selected, the first graphical object is replaced by a second graphical object, the second graphical object selectable to enable a bid.

In another broad aspect the invention consists in a system for controlling an online sale, the system comprising configured to control: a programmable control device operable to communicate with a set of subscriber electronic devices, each generating a graphical user interface for a subscriber to the online sale, a first subscriber server operable to store subscriber data carrying information identifying each subscriber, a second subscriber server operable to store data carrying information identifying a subset of subscribers dependent on inputs at the graphical user interfaces of each subscriber in the subset, the first or second subscriber server operable to upload a presentation to the graphical user interfaces at the subscriber device of each of the subset of subscribers, the presentation carrying real-time information (temporally varying), and operable to adjust the presentation dependent on data stored for one or more of the subset of subscribers, the one or more of the subset selected dependent on an input at the graphical user interface related to the real-time information carried by the presentation.

In another broad aspect the invention consists in a system for controlling an online sale, the system comprising: a first subscriber server operable to store subscriber data carrying information identifying each subscriber, a programmable control device in communication with the first subscriber server a plurality of subscriber electronic devices, a second subscriber server operable to store data carrying information identifying a subset of subscribers of first subscriber server dependent on receipt of an input message via a the graphical user interface provided to electronic device each subscriber.

In another broad aspect the invention consists in a system for facilitating an auction on an electronic device, comprising: a programmable control device, memory coupled to the programmable control device, wherein instructions are stored in the memory, the instructions causing the programmable control device to: send data to one or more user electronic devices in a user subscriber list, the data comprising details of an item-for-sale and an auction start time and configured for display on a user electronic device, receive an intent-to-enter message indicative from one or more user electronic devices opting to participate in the auction, display one or more auction parameters on participating user electronic devices, receive an intent-to-buy message from a user electronic device, and output a message indicative of an auction won to the user electronic device, and output a message indicative of an auction not won to other user electronic devices on the subscriber list.

In some embodiments, the intent-to-buy message comprises time stamp data and the winning user electronic device is associated with the intent-to-buy message having the time stamp data indicative of a fastest response.

In another broad aspect the invention consists in a system for facilitating an auction, comprising: a plurality of user electronic devices having a display configured to show auction information and provide user input, a programmable control device connected to the plurality of electronic devices by a communication network, memory coupled to the programmable control device, wherein instructions are stored in the memory, the instructions causing the programmable control device to: send data to user electronic devices in a user subscriber database, the data comprising an item-for-sale and an auction start time and configured for display on a user electronic device, receive an intent-to-enter message indicative from one or more user electronic devices opting to participate in the auction, display one or more auction parameters on participating user electronic devices, receive an intent-to-buy message from a user electronic device, and output an auction won message to the user electronic device, and output auction not won message to other user electronic devices on the list.

In another broad aspect the invention consists in a system for communicating with a plurality of electronic devices in a population of electronic devices, comprising: a user interface presented with a display configured to show data received from at least one server, wherein the server is configured to output data indicative of a time to each of the connected electronic devices.

In another broad aspect the invention consists in a graphical user interface for a display of a user electronic device, the user comprising a user contained on a subscriber database having connection via a network to the user electronic device, the interface comprising: an indication of auction details comprising an indication of the time remaining for the auction and an indication of the current price of the auction, a first graphical object selectable to enable bidding, wherein, when selected, the first graphical object is replaced by a second graphical object, the second graphical object selectable to enable a bid.

In some embodiments, selection of the first graphical object by a user causes data to be sent to an auction controller, the auction controller configured to compile a database of participant users.

In some embodiments, the auction participant is determined by the receipt of an intent-to-buy message received from one or more users in a database of users.

In some embodiments, second graphical object is moveable about the display from a first position on the display to a second position on the display, wherein the arrival of the graphical object at the second position causes a bid on the auction to occur.

In some embodiments, the arrival of the graphical object at the second position is operable to cause an intent-to-bid data message to be sent to an auction controller.

In some embodiments, the intent-to-bid data message comprises time stamp data indicative of the time the bid was placed.

In some embodiments, wherein the auction controller is configured to provide time synchronisation data to each auction participant devices who selects the first graphical object.

A system as claimed in any preceding claim, wherein the intent-to-bid data message further comprises time stamp data derived from the time synchronisation data.

In another broad aspect the invention relates to any one or more of the above statements in combination with any one or more of any of the other statements.

Other aspects of the invention may become apparent from the following description which is given by way of example only and with reference to the accompanying drawings.

As used herein the term “and/or” means “and” or “or”, or both. The term “comprising” as used in this specification and claims means “consisting at least in part of”. When interpreting statements in this specification and claims which include that term, the features, prefaced by that term in each statement all need to be present but other features can also be present. Related terms such as “comprise” and “comprised” are to be interpreted in the same manner.

It is intended that any reference to any range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference. This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 shows a system, generalised for use with embodiments.

FIG. 2 illustrates an example of a typical mobile device or smart phone including a block diagram of the hardware elements typically contained within.

FIG. 3 shows a detailed view of the features of a management system according to one embodiment

FIG. 4 shows a process according to one embodiment that is able to be facilitated, for example, by the system as shown in FIG. 3.

FIG. 5 shows a detailed view of a process undertaken by the programmable control device according to one embodiment.

FIG. 6 shows a detailed view of the process steps of FIG. 5.

FIG. 7 shows one example embodiment of a display screen.

FIG. 8 shows another example embodiment of a display screen.

FIG. 9 shows an interactive countdown

FIG. 10 shows another example of an embodiment of a display screen.

FIG. 11 illustrates an “IN” button.

FIG. 12 illustrates an example of an animation that can be displayed to a winning user.

FIG. 13 shows an example of a further display that can be shown to the auction winner.

FIGS. 14 to 17 show displays that can be shown to auction participants.

FIG. 18 and FIG. 19 show a summary of user participation across one or more auctions.

### DETAILED DESCRIPTION OF THE INVENTION

Exemplary methods and systems are described herein. It should be understood that the word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant to be limiting. It will be readily understood that certain aspects of the disclosed systems and methods can be arranged and combined in a wide variety of different configurations, all of which are contemplated herein.

The term “system” referred to in the specification and claims may comprise software, hardware, or a combination thereof. For example, the software can be machine code, firmware, embedded code, and application software. Also for example, the hardware can be circuitry, processor, computer, integrated circuit, integrated circuit cores, active or passive sensors, or a combination thereof.

The term “user” referred to in the specification and claims refers to an individual such as a person, or a group or people, or a business such as a retailer or advertiser of one or more a products or services.

Embodiments described herein relate to system that provides a mobile application and web platform to integrate online trading and gamification. Gamification refers to a process of making systems, services and activities more enjoyable and motivating for a user. Gamification commonly employs design elements used in games which are used in so called non-game contexts in attempts to improve user engagement, among other things.

The inventors have ascertained that providing an engaging live experience to a user is the best way to attract users or ‘Players’ who in term can be exposed to contextualised advertising. Therefore there is created the capacity to simultaneously build hype around products and services while creating clear pathways to increased customer registration and conversion. Consumer engagement is able to be improved by connecting retailers and brands with customers by exposing products and services to consumers in a stimulating environment.

Embodiments described herein relate to the provision of what is known as a reverse, drop or Dutch auction whereby an auction lasts only a short amount of time (for example, one minute) and the price of the item for sale falls from a maximum or recommended retail to zero over the course of the auction duration.

In a reverse auction, a potential bidder can place a bid at time during the duration of the reverse auction and the first bidder to place a bid wins that item being auctioned for the price of the item at the time the bid was placed. Therefore, the longer potential bidders take to place a bid, the lower the cost of the item will be, but the higher risk there is that another potential bidder will place a bid. A reverse auction therefore has only one bid. When that bid occurs, the reverse auction is completed.

Embodiments described herein relate to the determination of preferred customers of a retailer by analysing user data within each auction process such as age, sex, location and interests. For example, a customer may register by using their social media account and associated details. With this information, potential reverse auction participants can be targeted who are likely to be interested in a particular retailer and encourage them to visit that retailer by utilising a reward process.

Following completion of an auction, auction participants or winners are encouraged to visit retailer destinations for conversion. The opportunity for a retailer to capitalise on the excitement of the auction for the vendors increased profit can therefore be improved. Retailers may be both online stores and physical venues. For example, a reward can be offered to users participating in the auction whereby a product give-aways or in-store discount is offered. To create urgency, the rewards may have time limits imposed.

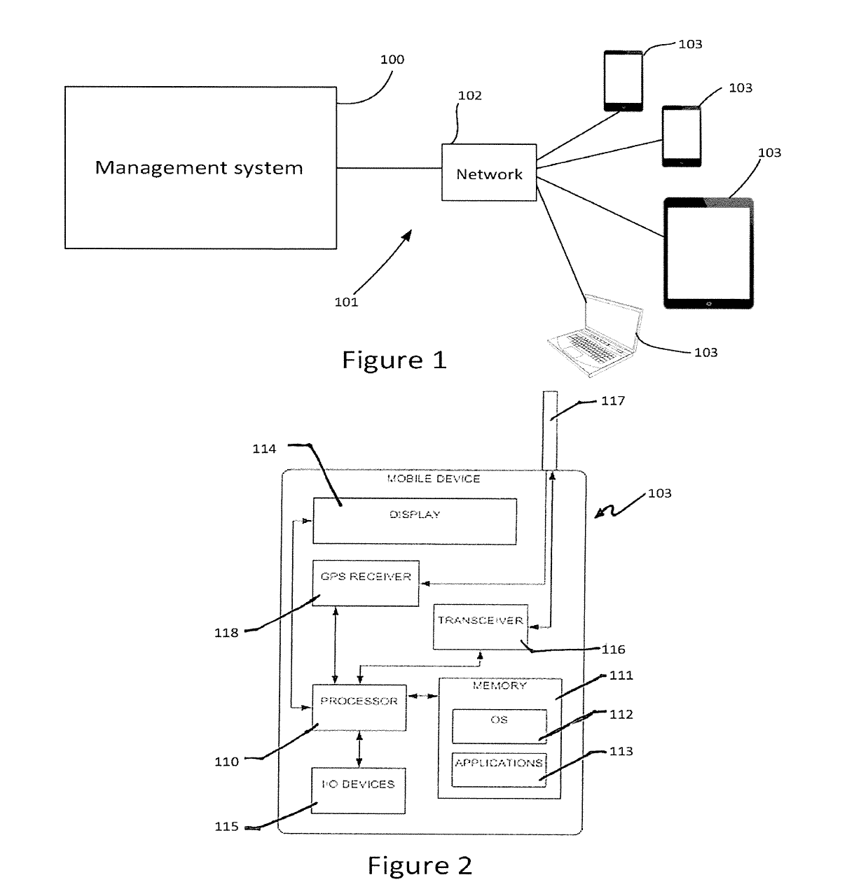

A system, generalised for use with embodiments of the invention, is shown in FIG. 1. The system 101 comprises a plurality of user electronic devices 103, operable manually by one or more users or prefigured to operate automatically, and connected to a server 100 via a communication network 102. The communication network may be a wired or wireless link such as a LAN, cellular networks, WiFi networks, the internet, repeater stations or a combination of two or more of these elements. Repeater stations such as ground based or satellite signal relay stations may also be included in the network 102.

The user electronic devices 103 can be any one of a variety of devices including cellular phones, smartphones, personal digital assistants, tablets, notebook computers, automotive navigation systems, smart televisions, wearable electronic devices or other multi-functional mobile communication or entertainment devices. The electronic devices 103 can also be a non-mobile computing device, such as a server, group of servers, or a desktop computer. The electronic devices 103 can be standalone devices, or can be incorporated with a vehicle, for example a car, truck, bus, aircraft, or train. Further, the electronic devices 103 communicate directly with other electronic devices 103. The devices may be hand held or integrated with a vehicle or building facility such as a wholesale or retail outlet 104. The electronic devices 103 can be further any of a variety of centralised or decentralised computing devices. For example, a computer, grid computing resources, a virtualized computer resource, cloud computing resource, routers, switches, peer-to-peer distributed computing devices, or a combination thereof. In particular, it is envisaged the devices 101 most applicable for use with embodiments described in this specification are hand held smartphone devices or tablets with touchscreen functionality as this is believed to encourage the greatest level of participation with the embodiments of the invention.

The communication network 102 depicted in FIG. 1 can be a variety of networks. For example, the communication network may have wireless communication, wired communication, optical, ultrasonic, or the combination thereof, satellite communication, cellular communication, Bluetooth and Infrared are examples of wireless communication that can be included. Ethernet, digital subscriber line, fibre to the home, telephone services are examples of wired communication that can be included in the communication network.

The user electronic devices 103 may further be equipped with a location information receiver device such as GPS receiver configured to receive GPS position information from overhead satellites and/or AGPS information from a land based positioning system.

FIG. 2 illustrates an example of a typical mobile device or smart phone including a block diagram of the hardware elements typically contained within. The mobile device 103 may include a processor 110 which may be any of a variety of different types of commercially available processors suitable for mobile devices. Memory 111, such as a Random Access Memory (RAM), Flash memory, removable memory or other type of memory readable by the processor, is typically accessible to the processor 110. The memory 111 may be adapted to store an operating system (OS) 112, as well as application programs 113. The processor 110 may be coupled, either directly or via appropriate intermediary hardware, to a visual display 114 and to one or more input/output (I/O) devices 115, such as a keypad, a touch panel sensor or touch sensitive interface, speaker and microphone.

The processor 110 comprises any processing circuitry or processor operative to control the operations and performance. For example, the processor can be used to run operating system applications, firmware applications, media playback applications, media editing applications, or any other application. In some embodiments, the processor can drive a display and process inputs received from a user interface.

In some embodiments, the display 114 is touch sensitive to allow a user to directly and physically interact with graphics displayed on the screen. A touchscreen is an input device normally layered on the top of the visual display of an information processing system operated on the user device. A user can give input or control the information processing system through simple or multi-touch gestures by touching the screen with a special stylus and/or one or more fingers. The user can use the touchscreen to react to what is displayed and to control how it is displayed. For example, touching the touchscreen could be for zooming text size or select virtual graphically represented buttons. The touchscreen enables the user to interact directly with what is displayed, rather than using a mouse, touchpad, or any other intermediate device (other than a stylus, which is optional for most modern touchscreens).

The processor 110 may be coupled to a transceiver 116 that interfaces with an antenna 117. The transceiver 116 may be configured to both transmit and receive cellular network signals, wireless data signals, or other types of signals via the antenna 117, depending on the nature of the mobile device 101. In this manner, a connection with the communication network may be established. Further, in some embodiments, a GPS receiver 118 may also make use of the antenna 117 to receive GPS signals or comprise another antenna for receiving GPS signals. The mobile devices discussed herein are capable of sending and receiving information through a network to a remote system, displaying information to users, and allowing users to input information.

To facilitate embodiments of the invention, the user device 103 includes a software application operable to receive information, display information, receive inputs from a user and transmit user input information to a remote location. The application may be downloaded from a virtual store such as an app store. Other means of loading the software application to the user device are possible.

In some embodiments, gamification of the auction environment is enhanced by a graphical display that provides an interactive response to user input. For example, a swiping motion may be provided for a touch sensitive display. For displays that are not touch sensitive, an interactive movement may be created by using a mouse or pointing device to select and move a graphical object displayed on the screen of the electronic device.

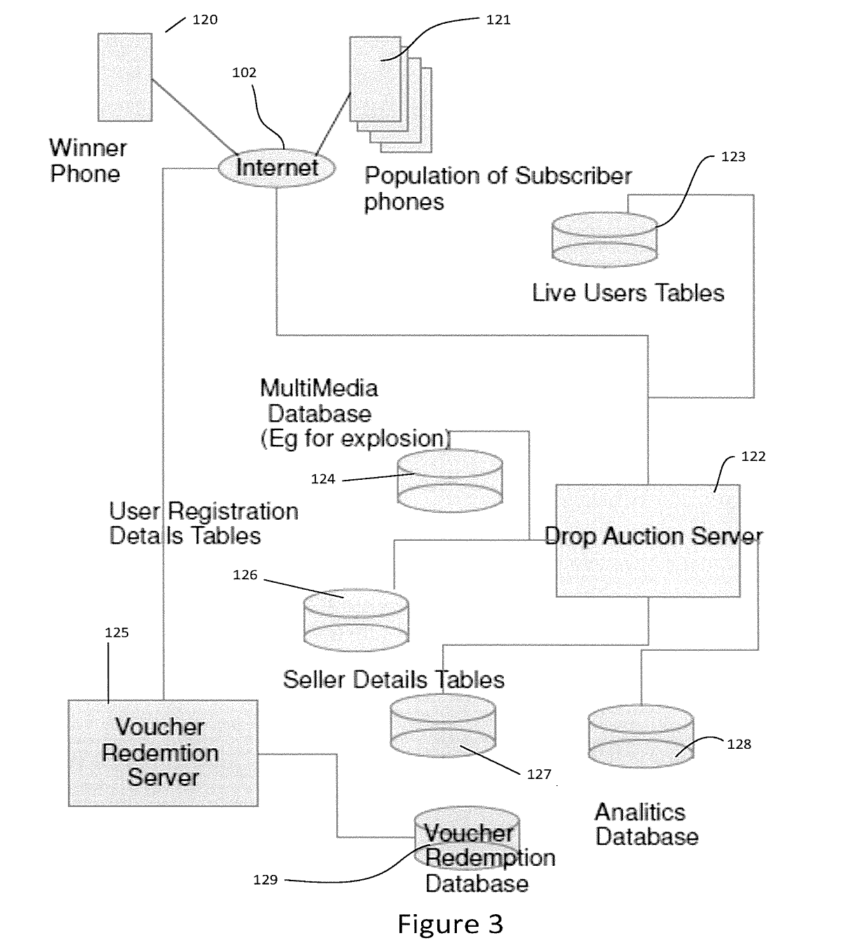

FIG. 3 shows a detailed view of the features of the management system 100 according to one embodiment. An auction server 122 facilitates one or more processes for harmonising items for sale with one or more users. For the purposes of this description, the server referred to is typically a machine capable of hosting a computer program that facilitates receives and responds to requests. The purpose of the server is to share data or hardware and software resources with other devices. The server may facilitate one or more functions such as a database server, file server, mail server, web server, and/or application server.

The auction server 122 typically has a programmable control device for executing instructions stored in memory. In some embodiments, the programmable control device is a computer. However, the programmable control device may equally be a device such as a microcontroller or programmable logic circuit. Memory is provided to store instructions for execution by the programmable control device. Further, memory may be provided to store other information such as user information and/or information pertaining for items for sale by auction. In some embodiments, the memory is made up of several memory devices which may be located in geographically distinct locations or in the same location. For example, memory devices may be provided as part of one or more servers with connection to the programmable device. Further, those servers may be located in different places such as local servers and cloud servers.

Memory can include, for example, one or more storage mediums including a hard drive, solid state drive, flash memory, permanent memory such as ROM, any other suitable type of storage component, or any combination thereof. The memory can store, for example, media data, application data firmware, user preference information data, authentication information (for example, libraries of data associated with authorized users), lifestyle information data, exercise information, transaction information data, wireless connection information data, subscription information data, contact information data calendar information data, and any other suitable data or any combination thereof. Memory can include cache memory, semi-permanent memory such as RAM, and/or one or more different types of memory used for temporarily storing data. In some embodiments, memory can also be used for storing data used to operate electronic device applications, or any other type of data that can be stored in storage. In some embodiments, memory and storage can be combined as a single storage medium.

In the embodiment shown in FIG. 3, several databases are shown that may be located together on one memory device or be spread across two or more memory devices. In particular, the auction server 122 is connected to a database containing a list of registered users 126, a database containing multimedia 124, a database with details of one or more seller 127 such as a retailer, and an analytics database 128.

In some embodiments, the auction server 122 is configured to generate one or more user subsets from the registered users. For example, the server may be configured to generate a list of users who are participating in an auction. Subsets are constructed by copying identifying user details from the user database 126 when data is received from that user indicating their participation in an auction.

The auction server 122 is connected to a number of user devices 121 via the network 102 which may be the internet. Of the user devices 121, the auction server will also be connected to a winner 120 when the auction completes.

In some embodiments, there is a prize server 125 connected with the user devices 121 via the network 102. The prize server may be incorporated into the auction server or be a separate unit. The prize server 125 is configured to store information relating to one or more prizes, and where or how those prizes are able to be received. Information relating to prizes is typically stored in a prize database 129 connected to the prize server 125.

Some or all of the databases may include I/O circuitry operable to allow communication between various devices. For example, I/O circuitry can be operative to convert (and encode/decode, if necessary) analogue signals and other signals into digital data. In some embodiments, I/O circuitry can also convert digital data into any other type of signal, and vice-versa. For example, I/O circuitry can receive and convert physical contact inputs (for example, from a multi-touch screen), physical movements (for example, from a mouse or sensor), analogue audio signals (for example, from a microphone), or any other input. The digital data can be provided to and received from control circuitry, memory, or any other component. It should also be understood that the auction software may be located and executed on the storage device/medium of a single server or may have separate portions distributed on various servers that interact with each other.

The auction server 122 is preferably a programmable control device with memory, such as the user details server, the auction details server and the participant database. One or more of the servers or a memory device on the server stores instructions that are executable by the programmable control device. The instructions are such that the programmable control device will send data to one or more user electronic devices in the user subscriber database.

The data includes information about to an item-for-sale such as cost and a time the auction will start. For example, the user electronics device may be programmed to receive the data and parse selected items for display, such as that auction data. The user electronic device is further configured to provide interactive graphical objects that allow the user to select. The user electronic device may be configured, for example, by downloading a software application that will interface to physical elements of the user device such as a display and user control interface, and allow data to input and sent to the server 122, and receive data from the server for display. Data for display could include graphical representative of a button, where the interface detects the button has been click, selected or swiped, communication that detection and in response perform a function. One function provided by a button indicative of a user intention to enter or participate in an auction is used to send a data message to the auction server. The server receives the data message and identifies the user from the users in the user subscriber database 126. The programmable control device then generates a list of participant users from the list of subscriber users based on receipt of a data message from each user indicating they want to participate in that auction. Users in the participation list are provided further information relating to specific auction details and each electronics device of users in the participant list is provided with auction information to present on the display to the user including a button to buy, or at least an intention to buy, the item. For example, the user electronic device may be configured to send the programmable control device information relating to an intent-to-buy message from a user electronic device. In response, the programmable control device may be configured to output an auction won message to the user electronic device, and output message indicating someone else has one the auction to other user electronic devices on the list.

In some embodiments, the user electronic device has or provides a graphical user interface for a display of the user of the electronic device. The user is one from on a subscriber database having connection via a network to the user electronic device. For example, the interface may display an indication of auction details such as an indication of the time remaining for the auction and an indication of the current price of the auction. Further, the interface may display a first graphical object selectable to enable bidding, wherein, when selected, the first graphical object is replaced by a second graphical object. Data representing the section of the graphical object is sent to a remote server configured to generate a participant list. The second graphical object may be selectable to enable bidding on the auction.

In some embodiments, the auction server is part of a system for controlling an online sale and has a programmable control device operable to communicate with a set of subscriber electronic devices that each generates a graphical user interface for a subscriber to the online sale. The system has a first subscriber server operable to store subscriber data carrying information identifying each subscriber and a second subscriber server operable to store data carrying information identifying a subset of subscribers dependent on inputs at the graphical user interfaces of each subscriber in the subset. The first or second subscriber server are operable to upload a presentation to the graphical user interfaces at the subscriber device of each of the subset of subscribers. The presentation has real-time information (temporally varying) and operates to adjust the presentation dependent on data stored for one or more of the subset of subscribers. For example, the real time information includes the current price of the item for same in a drop auction and/or the time remaining in a drop auction. One or more of the subset selected is dependent on an input at the graphical user interface related to the real-time information carried by the presentation.

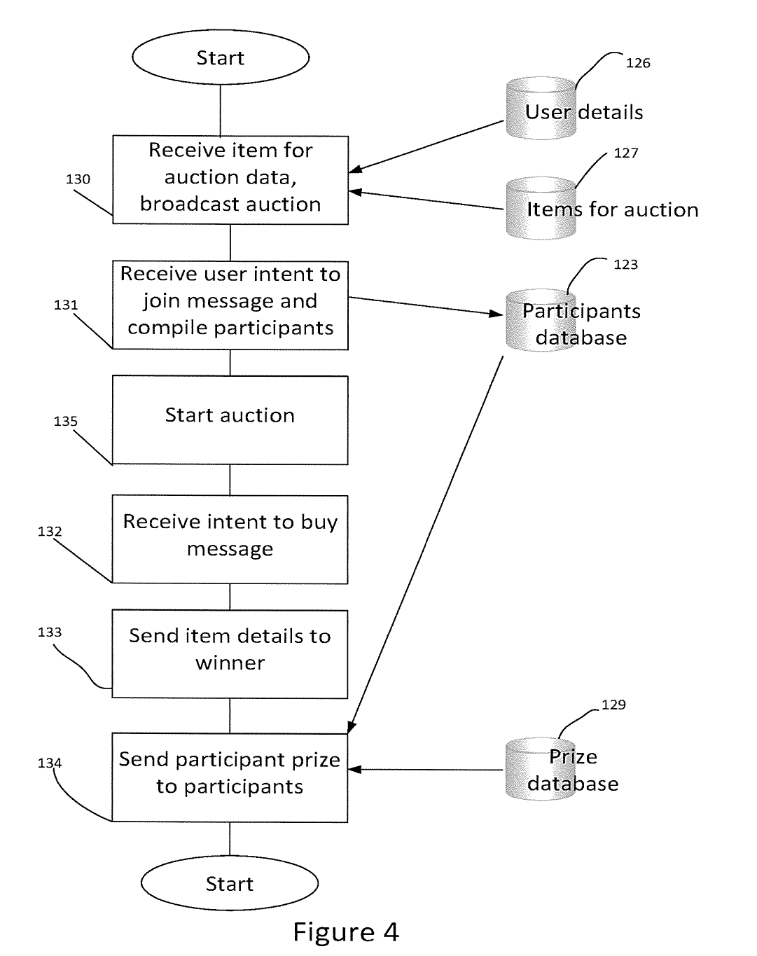

FIG. 4 shows a process according to one embodiment that is able to be facilitated, for example, by the system as shown in FIG. 3. To start a reverse auction between a central and a number of subscriber users, auction data is retrieved 130 from the items for auction database 127 and subscriber user details are retrieved from the user database 126. The particular goods or service to be auctioned may depend on considerations including the time of day and advertiser revenue. The users included may be all users in the database or it may be a selection of users. For example, a selection of users of a particular demographic or interest ground may be most likely to be interested in the item for sale. The item to be auctioned is broadcast 130 to the users together with auction information such as the time the auction will begin and details of the product to be sold.

Users receive the auction details on their mobile devices or computers, preferably on dedicated application software configured to display auction information. For example, the auction software is configured to receive the auction details, including time of the auction, and display key data such as a clock showing the time of the auction, or time remaining until the auction begins. The software application may be further configured to display details regarding the item for sale. For example, a picture of the product or service may be provided together with any relevant price information.

The application software is further configured to provide a button optionally selectable by the user of the device indicating the user wants to join the auction and enable them to bid. For example, the application software is configured to send an ‘intent-to-bid’ message to the auction server when the button is selected. The button selection can be made, for example, by a click or by the user holding their finger on a button constantly for a period of time or until the auction has ended. In preferred embodiments, a button is provided on the user interface and an ‘intent to bid’ message is sent to the server when the user holds their finger on the button. Once the intent to bid message is received from a user, that user is added to a list of participant users. If the user deselects the button during the auction, the user is removed from the participant list.

Other features as possible to be implemented while the intent to buy button is selected, such as an accumulation of points or redeemable awards. In such cases, a user is encouraged to endure the length of the auction, and be exposed to longer advertising, because the longer they hold their finger on the button, the more points will be accumulated. The selection of the intent to buy button for as long as possible encourages the user feels to feel excited as they are poised to bid on the auction.

At step 131, the auction server 122 is configured to receive user information and compile or store a list 123 of the users that want to participate in the auction. One method to encourage user participation is to offer prizes for entering the auction based on the amount of time a user selects the intent to bid button.

At step 135, the auction is started. In a reverse or drop auction, there is a timer provided to auction participants that displays the time remaining in which to bid. Typically, the price of the item being auctioned will start at a high price and reduce as time progresses until a bid is placed. The first person to place a bid is the winner of the auction. Those participants who are not first to place a bid do not win the auction. The bid may be placed, for example, by provision of a user interface that allows a user to drag the button they are presently holding down. A swiping motion may be used to drag the position of the button on a display screen to a target. The swiping motion from the initial button location to a target, which may be located elsewhere on the screen, is the action required to make an intention to buy.

In a preferred embodiment, when a user selects the intent to buy button, the application program responds by displaying graphics of a target button located some distance from the intent to bid button. To place a bid, the user must swipe or drag the position of their finger or mouse icon across the display to the location of the target button. The path between the intent to bid button and the target button may be embellished with graphics such as animated arrows pointing toward the target button.

At step 133, the auction is won when a message is received from a user indicating they want to place a bid on the item for sale at the currently displayed price. At step 133, the winning user is sent details of how they are able to retrieve the item they have won. The details may include a physical or online retail store location where a product or service is able to be obtained.

At step 134, the list of participants is retrieved from the database of participants 123 and a prize is retrieved from the prize database 129. Details on a prize that can be redeemed are sent to the participants of the auction who did not win. The provision of the prize motivates users to join the auction and potentially bid. However, the provision of the prize further motivates users to redeem the prize, which may be, for example, an item that may only be redeemed at a physical or online retail store.

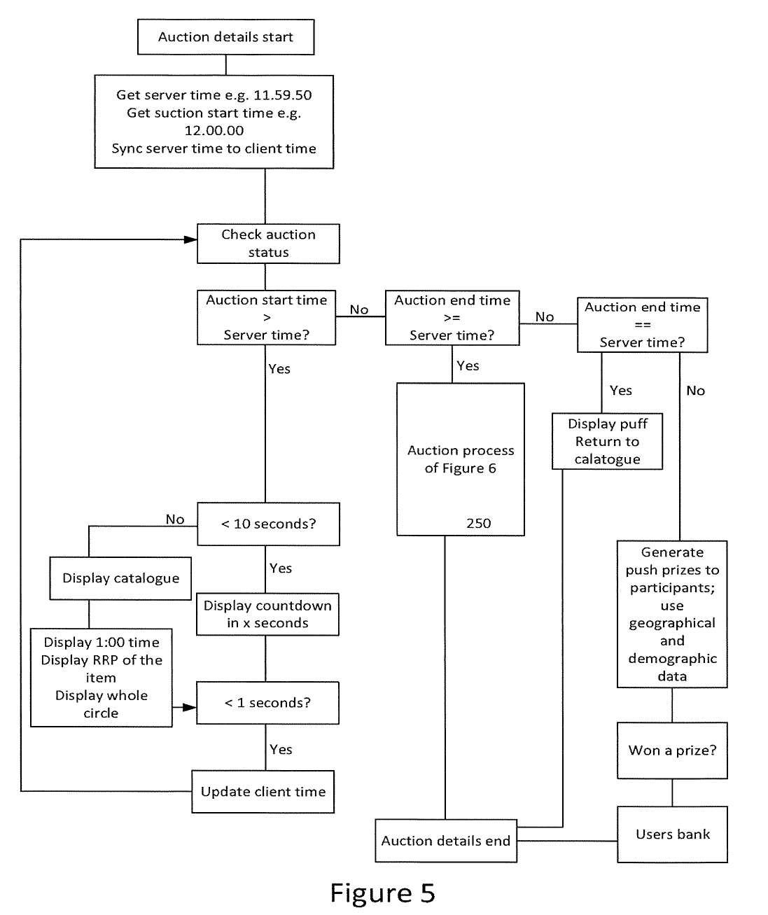

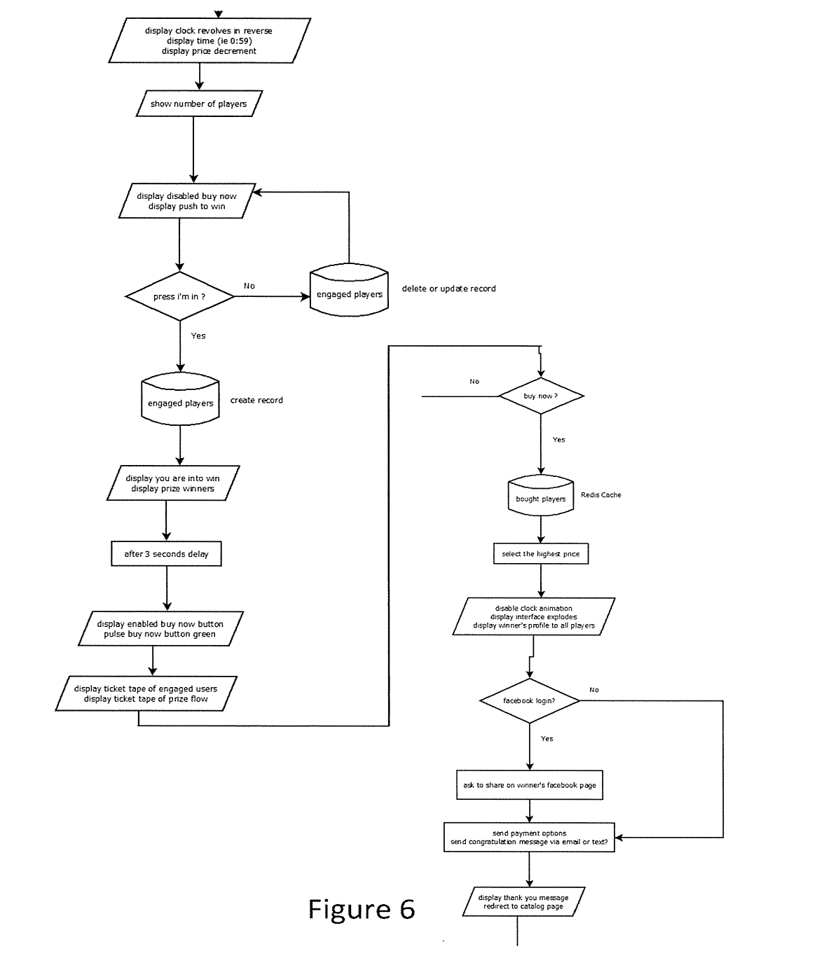

FIG. 5 shows a detailed view of a process undertaken by the programmable control device according to one particular exemplary embodiment and FIG. 6 shows a detailed view of the process steps 250. Before the auction begins, the display shows relevant information to users.

In one exemplary embodiment as outlined by FIGS. 5 and 6, the reverse auction process shown in FIG. 4 can be implemented by a system that includes an auction server and number of user devices in communication with the auction server via a data communication network in communication. The server has memory that stores a database with a list of subscriber users. The server also has a clock that is used as temporal reference for each of the user devices, i.e. to synchronise each of them so that the user of each user device has accurate information on the time remaining in the reverse auction. The server also stores information relating to an item subject to the reverse auction, an initial cost of the item subject to the reverse auction, a time when the reverse auction is due to commence.

Each user device has memory configured to store software such as an application program that controls the interface of the user device and communication with the server via the data communication network. In particular, the application program is configured to cause instructions to receive, from the server, the reverse auction data. The application program is configured to receive, from the server, clock data to enable time synchronisation between the user device and the server. The application program is also configured to cause display the reverse auction data on the interface of the user device.

The reverse auction will typically commence at a predetermined time that allows users to organise to be present for. Being present merely means the user loads the application program on their user devices and allowing that user device to send to and receive data from the server. The application program may optionally be configured to display a countdown before the live auction commences. For example, the countdown may be a multimedia display of the last 10 seconds which will build user suspense and promote engagement with the reverse auction process.

The application program is also configured to generate graphics that are to be displayed on the user device. The graphics includes at least the display of a button graphic at a first location on the interface, and display a target graphic on the interface of each user device of at least each participant user and shown at a second location of the interface. In some embodiments, the display of graphics is dependent on whether the user of the user device has logged in and/or selected that they desire to participate in the reverse auction.

The application program is configured to detect a user of the user device has selected a graphic or virtual button that enables the user to participate in the reverse auction and send data to the server indicative of the user selecting that button. The server is configured to the data which notifies that the user is eligible to participate in the reverse auction.

The server stores in memory a list of subscriber users. From the list of subscriber users, further subsets of users are created. When a reverse auction is scheduled to occur, the server may be configured to send a notification to each subscriber user as a reminder. Subscribers users with or without notification are able to load the software application on their user devices and receive data relating to the one or more reverse auctions scheduled to occur. A user desiring to take part in the reverse auction process sends indicative data to the server. The data may be sent as a result of the user selecting a virtual button displayed on their device. The data will include details relating to the user so that the server is able to identify the user the data is received from. The server is configured to then generate a subset of ‘live’ users who wish to take part in the auction from the list of subscriber users.

Once the reverse auction commences, a user is provided with further virtual buttons. In a preferred embodiment, a first button must be selected and held for the user to be eligible to place a bid on the reverse auction. The first button may also need to be selected and held for a minimum amount of time to be eligible to place a bid on the reverse auction. The server is configured to receive data from the user device indicating a user has selected and held the first virtual button. The server is configured to create a subset of users who are participating in the auction from the list of live users. The list of participant users, together with the duration of a user being a participant user can be used to stimulate secondary functions such as bonus promotions as described elsewhere. Once a user is in a participant list, if not before, the server is configured to send data to the user device to enable synchronisation of the user device time with the clock of the server. This ensures all users are time synchronised with the time remaining in the reverse auction and the present decreasing cost of the item for sale.

For a user to place a bid, they must drag, such as a finger dragging on a touchscreen, or a mouse being clicked and moved, from the first location of a virtual button where they have selected to participate, to a second location of a virtual target where, upon reaching the target, a bid is placed. For example, the application program may be configured to control the user device of each live user to display a countdown time on the interface the user device, synchronised with the server clock and associated with a time remaining in the reverse auction process. The application program controls the user device of each live user to display the cost of the item on the interface of each user device and decreasing the cost of the item based on the countdown time. The application program detects a dragging motion from the first location of the interface of a user device of a participant user to a second location. The application program then determines the dragging motion has reached the second location, determining the clock time the dragging motion reached the second location then, displays graphics indicative of the reverse auction ending.

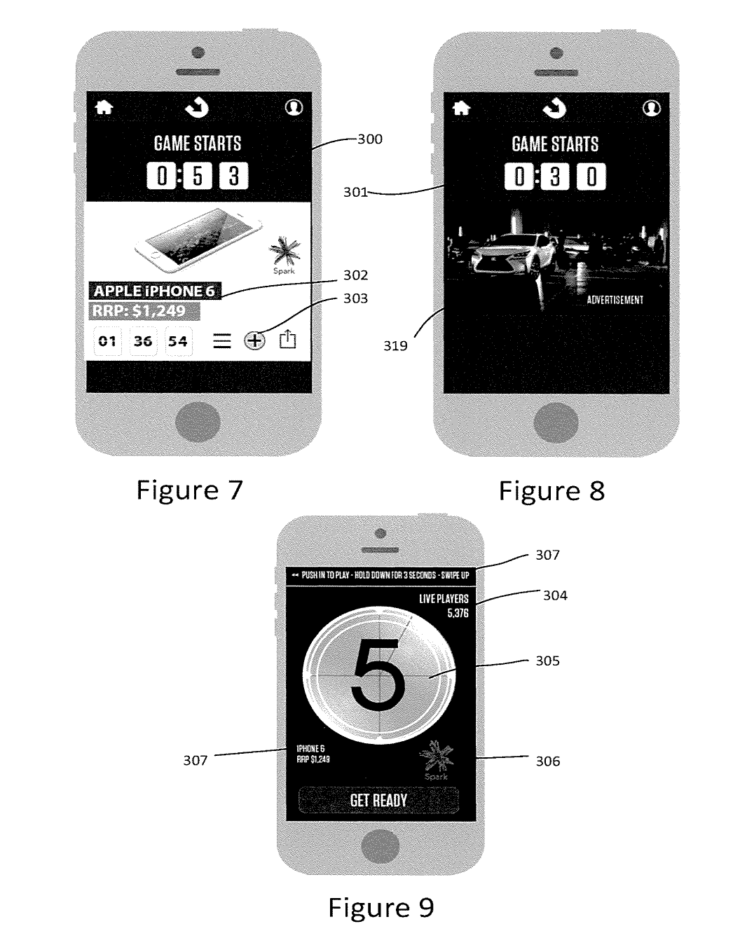

FIG. 7 shows one example embodiment where a timer 300 shows the time remaining until the auction begins. Also shown is the item to be auctioned 302 which may include one or more photos and a written description. A button 303 is provided to the user which they may select to add the upcoming auction to a watch list to provide future notification the auction will take place. Once the button 303 is pressed, the display may change to a new display showing one or more advertisements 319 as shown in FIG. 8. In preferred embodiments, the button is pressed continually until either: the user places a bid by swiping the button to the target, the auction ends and the button is configured to disappear, or the user releases the button and they are disabled from placing a bid and removed from the auction participants list.

An interactive countdown timer 305 is provided to the display before the auction starts such as shown in FIG. 9. Information about the item to be auctioned 307 may optionally be shown together with relevant supplier information such as branding 306. The number of players may also be shown 304 so that the user may anticipate the level of participation by other users and the likely level activity in the auction. Such factors improve the gamification of the environment.

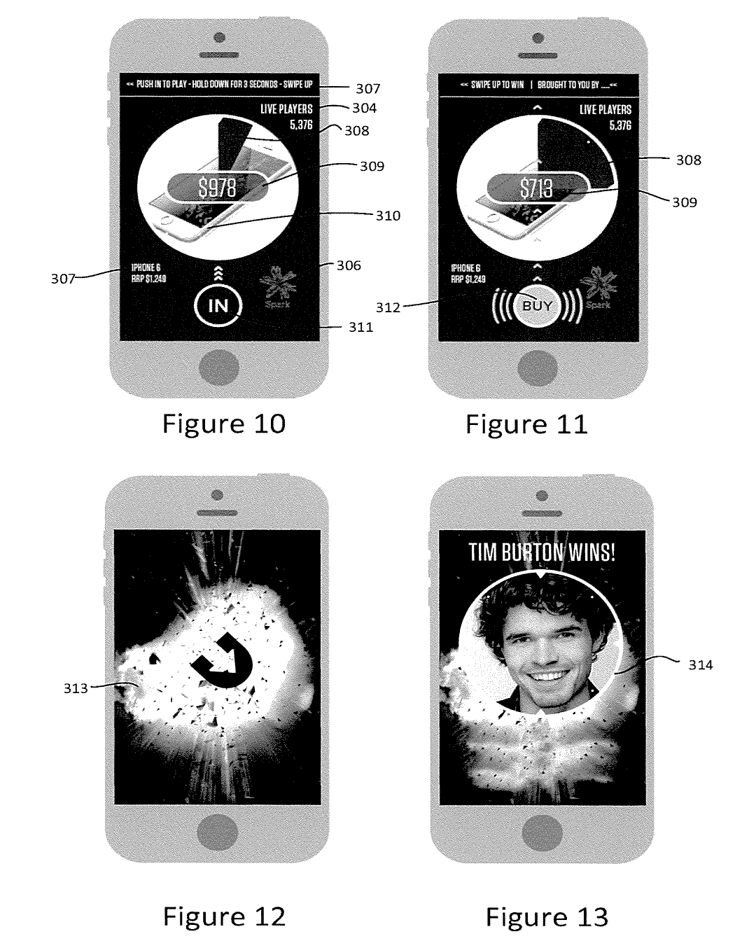

FIG. 10 shows an example of the display when the auction commences. A clock, specifically a drop clock, is shown 308. In exemplary embodiments, the drop clock 308 is animated, as shown here by a coloured region that rotates around the clock face as time progresses. An image of the item for sale is shown in the background to the clock 310. As time progresses, the amount the item will sell for is shown 309 and decreases by a set amount. For example, the item cost may start at a retail price and drop to zero over the course of the auction.

A button 311 allowing a user to place a bid on the auction is provided. FIG. 11 illustrates an “IN” button. When a user selects the button, the buttons is changed to a “BUY” button as shown in FIG. 11. The button transition from “IN” to “BUY” provides a first function in that accidental button presses to buy the item being auctioned are mitigated, and secondly to allow the user to engage with the auction process and build a further level of anticipation. As the auction progresses, the clock 308 increases and the price 309 drops. Once the “BUY” button has been enabled, a user is able to select, or select and drag the button to place a bid at the currently shown price to win the auction.

FIG. 12 illustrates an example of an animation 313 that can be displayed to a winning user and/or all users who have participated in the auction. FIG. 13 shows an example of a further display that can be shown to the auction winner and/or all users who have participated in the auction. For example, the name or a photo of the winning user 314 could be displayed.

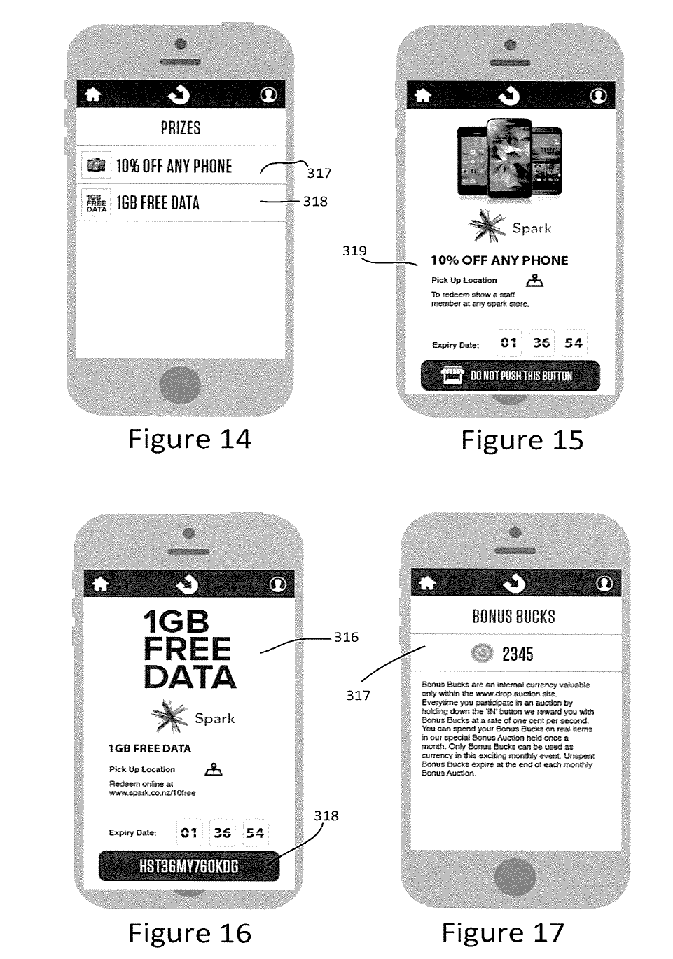

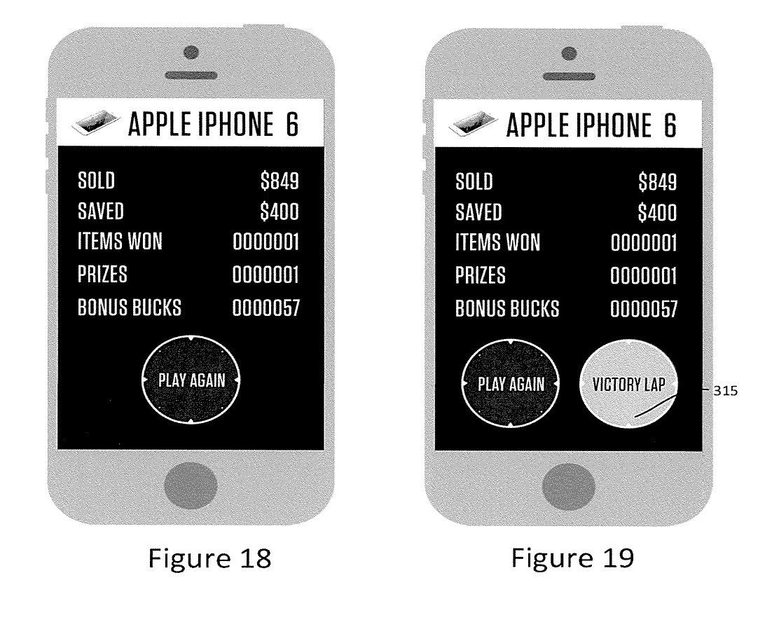

FIGS. 14 to 17 show a display that can be shown to auction participants including the option to obtain prizes 316, 317, 318, 319 that may be redeemed in a retail or online store. Therefore there may be provided conventional advertising space with a wide range of placement opportunities. The core reason to advertise is to increase consumer visits to retail or online stores which in turn leads to improved conversions. FIGS. 18 and 19 show a summary of user participation across one or more auctions and may include the option to display a celebrative multimedia display by selecting a button 315.

From the perspective of a person wishing to engage with the reverse auction process, playing is very simple, first the user has to register by either signing up with Facebook or by entering your details in to the text fields. Once the user has registered the user is eligible to participate in the reverse auction.

Each auction has a start time shown by an auction image. Auctions start automatically and will take over the browser window. After viewing advertising media and the 5 second countdown timer you will then enter the live no reserve reverse auction. In the centre of the screen you will see the clock that counts down for one minute. During the one minute reverse auction duration the price drops from its full retail price to zero.

For a user to bid and win they need to hold down the (IN) button for three seconds with either their finger on a smartphone touchscreen display or by clicking and holding with a mouse on their computer. Once the user has held down for three seconds the (IN) button will have turned yellow and changed to (BUY), the user will also see the upward pulsating arrows encouraging them to swipe up.

The user are not buying anything if you are just holding down the (IN) button. If the user is wanting to buy the auction item all they need to do is swipe up through the drop clock at the price you wish to pay and if they are the first auction participant to do so, they will win the auction.

While the user is holding down the (IN) button you are earning ‘Bonus Bucks’ which is an internal currency that can be used to buy real items on the Bonus Buck auctions that run at the end of each month. While the user is holding down the (IN) button the user also has a chance to win prizes that get sent to a user ‘Prize Bank’.

Watch List Tip: While browsing through the auction catalogue a user can add items to their Watch List so the server can be programmed to send reminders for when the auctions are about to start.

In use, the programmable control device is configured to send data to users in the subscriber database. The data includes details regarding the item-for-sale and an auction start time. A software application running on the electronics devices is configured to receive the auction data and display the data on the electronic device of each user. The programmable control device is further configured to receive an intent-to-enter message indicative from one or more users opting to participate in the auction, for example, when a user selects a button indicating their desire to be eligible to bid on the auction. Once the drop auction process is underway, a user is able to select an interactive graphical display on their electronic device that is operable to send an intent-to-buy message to the programmable device over the network. The first intent-to-buy message received by the programmable control device is the winning user. Each intent-to-enter message received by the programmable device is used to compile a list of participant users to which prizes or rewards offers are provided upon conclusion of the auction.

In some embodiments the programmable control device is configured to time synchronise each participant electronic device with a central clock that may be implemented on the server. Time synchronisation is critical to ensuring multiple users are synchronised to a common time.

In some embodiments, when a user opts in to the auction, the auction server 122 is configured to send data the users electronic device 103 that is operable to synchronise the auction time with a common time. In this way, each user device is provided time synchronise auction information which may include the current auction start time, the auction time remaining, the present cost or present bid of the item, and how many users are currently participating in the auction process. Further, time synchronisation all ensures or substantially ensures that when a bid is placed to win the auction, other users are immediately notified so that no bids are placed in vein. To this end, when a user places a bid, a data message is sent from the user's electronic device to the auction server. In some embodiments, the message includes a time stamp based on time synchronised data received from the auction server. If several bids are received in a short space of time, the auction server is configured to determine the received message that has a time stamp indicative of the earliest bid being placed. Accordingly, the earliest bid corresponds to the winner of the auction.

Wherein the foregoing description reference has been made to elements or integers having known equivalents, then such equivalents are included as if they were individually set forth. Although the invention has been described by way of example and with reference to particular embodiments, it is to be understood that modifications and/or improvements may be made without departing from the scope or spirit of the invention.

1. A method of controlling a reverse auction for an audience of subscriber users, the subscriber users each having a user device adapted for communication with and control by a remote auction server adapted to host the reverse auction, the method comprising:
storing, on the server, a list of subscriber users;
storing, on the server, reverse auction data comprising: an item subject to the reverse auction, an initial cost of the item subject to the reverse auction, a time when the reverse auction is due to commence;
generating, on the server, a clock signal adapted to provide a time synchronisation signal;
determining one or more live users from the list of subscriber users, creating a live user list of determined live users, then controlling the user device of each user on the live user list to display the reverse auction data;
synchronising the user device of each live user with the server clock;
commencing the reverse auction at the time the reverse auction is due to commence;
detecting a user, from the live user list, has selected a first location on an interface of their user device corresponding to a button graphic, storing a list of participant users on the server as a subset of the live users, then notifying each participant user that they are eligible to participate in the reverse auction;
controlling the user device of each live user to display a countdown time on the interface of each user device, synchronised with the server clock and associated with a time remaining in the reverse auction process;
controlling the user device of each live user to display the cost of the item on the interface of each user device and decreasing the cost of the item based on the countdown time;
controlling the user device of each live user to display a target graphic on the interface of each user device of at least each participant user and shown at a second location of the interface;
receiving, from any one or more user devices, a signal indicative of a user selecting the target graphic, and, storing, on the server, a list of participant users determined as the any one or more users who have selected the target graphic;
controlling the user device of each user on the participant user list to display eligibility to bid on the auction;
detecting a dragging motion from the first location of the interface of a user device of a participant user to a second location; and
determining the dragging motion has reached the second location, determining the clock time the dragging motion reached the second location then, ending the reverse auction.

2. The method of claim 1 further comprising:
determining a winning user from the list of participant users by determining the user who reached the second location first according to the first user to reach the second location according to the highest clock time, and
notifying the winning user they have won the reverse auction.

3. The method of claim 2, wherein notifying the winning user comprises notifying the winning user of the cost of the item at the time the reverse auction was stopped according to the clock.

4. (canceled)

5. The method of claim 1, wherein a participant user is determined after a live user has selected the first location of the interface for at least a predetermined selection time.

6. (canceled)

7. The method of claim 1, wherein the method further comprises detecting deselection of the first location by any participant user, once the reverse auction has commenced and before the reverse auction has ended, then removing that participant user from the participant user list.

8-13. (canceled)

14. The method of claim 1, wherein the method further comprises displaying advertising media on each user device before the reverse auction commences.

15. The method of claim 1, wherein the method further comprises notifying each participant user of secondary prize information when the reverse auction has ended.

16. The method of claim 15, wherein the secondary prize information is one or more redeemable coupon for a purchasable item related to the auction item.

17. The method of claim 1, wherein the method further comprises determining the length of time each participant user has selected the first location for, then determining the value of the vouchers is based on that length of time.

18-20. (canceled)

21. A non-transitory computer-readable medium product, the non-transitory computer-readable medium containing instructions thereon that, when executed by at least one processor, perform a method, the method comprising:
causing a reverse auction for an audience of subscriber users, the subscriber users each having a user device adapted for communication with and control by a remote auction server adapted to host the reverse auction;
the method further comprising:
storing, on the server, a list of subscriber users;
storing, on the server, reverse auction data comprising:
an item subject to the reverse auction,
an initial cost of the item subject to the reverse auction,
a time when the reverse auction is due to commence;
generating, on the server, a clock signal adapted to provide a time synchronisation signal;
determining one or more live users from the list of subscriber users, creating a live user list of determined live users, then controlling the user device of each user on the live user list to display the reverse auction data;
synchronising the user device of each live user with the server clock;
commencing the reverse auction at the time the reverse auction is due to commence;
detecting a user from the live user list has selected a first location on an interface of their user device corresponding to a button graphic, storing a list of participant users on the server as a subset of the live users, then notifying each participant user that they are eligible to participate in the reverse auction;
controlling the user device of each live user to display a countdown time on the interface of each user device, synchronised with the server clock and associated with a time remaining in the reverse auction process;
controlling the user device of each live user to display the cost of the item on the interface of each user device and decreasing the cost of the item based on the countdown time;
controlling the user device of each live user to display a target graphic on the interface of each user device of at least each participant user and shown at a second location of the interface;
receiving, from any one or more user devices, a signal indicative of a user selecting the target graphic, and, storing, on the server, a list of participant users determined as the any one or more users who have selected the target graphic;
controlling the user device of each user on the participant user list to display eligibility to bid on the auction;
detecting a dragging motion from the first location of the interface of a user device of a participant user to a second location; and
determining the dragging motion has reached the second location, determining the clock time the dragging motion reached the second location then, ending the reverse auction.

22. A system for a reverse auction, comprising:
an auction server comprising:
a database configured to store a list of subscriber users;
a clock;
a data communication network in communication with the information server;
a plurality of user devices, each user device having a communication module configured to communicate with the auction server via the data communication network;
wherein each user device has, a memory configured to store an application program and an interface configured to facilitate display and operation of the application
program by the processor, wherein the application program includes instructions to:
receive, from the server, reverse auction data comprising:
an item subject to the reverse auction,
an initial cost of the item subject to the reverse auction,
a time when the reverse auction is due to commence;
receive, from the server, a clock signal adapted to provide a time synchronisation between the user device and the server;
display the reverse auction data on the interface of the user device;
commence the reverse auction at the time the reverse auction is due to commence;
display a button graphic at a first location on the interface;
send data to the server indicative of the user selecting the button graphic;
receive notification the user is eligible to participate in the reverse auction;
control the user device of each live user to display a countdown time on the interface the user device, synchronised with the server clock and associated with a time remaining in the reverse auction process;
control the user device of each live user to display the cost of the item on the interface of each user device and decreasing the cost of the item based on the countdown time;
control the user device of each live user to display a target graphic on the interface of each user device of at least each participant user and shown at a second location of the interface;
receive, from any one or more user devices, a signal indicative of a user selecting the target graphic, and, storing, on the server, a list of participant users determined as the any one or more users who have selected the target graphic;
control the user device of each user on the participant user list to display eligibility to bid on the auction;
detect a dragging motion from the first location of the interface of a user device of a participant user to a second location; and
determine the dragging motion has reached the second location, determining the clock time the dragging motion reached the second location then, display graphics indicative of the reverse auction ending.

23. A system for determining purchase intent data of a reverse auction participant comprising a server having clock, reverse auction data including a start time and a subscriber list, the server in communication with a plurality of user devices of a plurality of users via a data communication network, the server configured to:
transmit the auction data to the plurality of user devices in the subscriber list;
receive data from a user in the subscriber list indicative of the user viewing the auction;
create an active user list as a subset of the subscriber list based on data received from
each member indicative of the user viewing the reverse auction;
synchronise each user device in the active user list with the clock;
determine a participant user based on data received from a user in the active users list indicative of participating in the reverse auction based on detection of a physical interaction of the user with their user device;
create a participant users list as a subset the active users list;
determine a measure of purchase intent data relating to each participant user based on the length of time each participant user based on the length of time of the physical interaction;
receive bid data and clock data from a user device in the participant users list;
wherein the bid data comprises detection of movement from one location of an interface of a user device corresponding to a button to a second location of the interface of the user device corresponding to a target; and
wherein a winning user is determined by the clock data representing a bid made in the least amount of time since a start of the reverse auction.

24-25. (canceled)

26. The method of claim 1, wherein the method further comprises determining a measure of purchase intent data, of each participant data, the purchase intent data based on the length of time each live user is also a participant user.
